(19) United States
(12) Patent Application Publication
(10) Pub. No.: US 2007/0295696 A1
(43) Pub. Date: Dec. 27, 2007

(54) Electrode for Electric Discharge Machining, and Electric Discharge Machining Method

(75) Inventors: Nobuyoshi Nabekura, Kanagawa (JP); Sadao Sano, Kanagawa (JP)

Correspondence Address: MCDERMOTT WILL & EMERY LLP, 18191 VON KARMAN AVE., SUITE 500, IRVINE, CA, 92612-7108, US

(73) Assignee: SODICK CO., LTD., YOKOHAMA, KANAGAWA (JP)

(21) Appl. No.: 11/792,243

(22) PCT Filed: Dec. 20, 2005
(86) PCT No.: PCT/JP05/23835

§ 371 Date: Jun. 4, 2007

(30) Foreign Application Priority Data
Dec. 20, 2004 (JP) 2004-367128

(51) Int. Cl. B23H 1/06

(52) U.S. Cl. 219/69.15; 219/69.17

(57) ABSTRACT

A sintered electrode for electric discharge machining comprises a continuous phase consisting of a conductive region (3), and a dispersed phase consisting of microscopic polycrystalline diamond (2) dispersed in the continuous phase. The conductive region (3) is cobalt, nickel, cobalt nickel alloy or cemented carbide and imparts conductivity to the electrode (1). The microscopic polycrystalline diamond (2) imparts excellent mechanical strength and thermal diffusion to the electrode (1). The electrode (1) and the workpiece (5) are connected to a power supply (V1) in reverse polarity and a current pulse having ON-time of 60 μ seconds or less and 1 μ second or more and peak of 15 A or less and 1 A or more is supplied to the electrode (1) from the power supply (V1).

### FIELD OF THE INVENTION

The present invention relates to a sinker electric discharge machining method for shaping a required cavity inside a workpiece by causing electrical discharge in the so-called “gap”, a microscopic gap formed between a tool electrode and a conductive workpiece. In particular, the present invention relates to a tool electrode used in a sinker electric discharge machining method.

### BACKGROUND ART

A tool electrode for electric discharge machining (hereafter referred to as “electrode”) is manufactured from a material such as copper, copper tungsten alloy, silver tungsten alloy, graphite or copper graphite, from the viewpoint of high machining rate, low wear and inexpensive manufacturing cost. In the case of using a copper or graphite electrode in dielectric fluid (hereafter referred to as machining fluid) with oil as a base, electric discharge machining called “low wear” is known. Low wear means an electrode wear rate of about 1%, and also means specific electrical conditions. A polarity where the electrode is positively poled, and a workpiece is negatively poled is selected. This polarity is called reverse polarity. A pulse current having a peak of from several tens to a hundred and several tens of A flows through a gap during an ON-time of several hundred to several thousand μ seconds. Under conditions such as these, machining fluid is thermally decomposed due to electric discharge, and carbon is generated. The carbon adheres to the surface of the electrode, and forms a carbon layer (also called a black layer). The fact that a carbon layer protects the electrode and lowers wear is known from Nishimura et al., “Study on the low electrode-wear electrical discharge machining—black layer of electrode surface”, Journal of the Japan society of electrical-machining engineers, Page 71, Vol. 1/No. 2 (1968), and Suzuki et al., “A study on the electrode wear in electrical discharge machining (1st report)”, Journal of the Japan society of electrical-machining engineers, page 47, Vol. 26/No. 52 (1992). However, there are the following problems with respect to low wear.
1. Generally, in order to finish the surface roughness of a workpiece to 1-5 μmRz, ON-time of a current pulse is set to 5 μ seconds or less. Accordingly, it is difficult for carbon to adhere to the electrode surface, and electrode wear rate increases to 10% or more.

2. In the case where the material of the workpiece is a high melting point (3000° C. or more) cemented carbide, the material removal rate is lowered. Table 1 shows electrode wear rate for the case of machining with straight polarity where an electrode is negatively poled and a cemented carbide workpiece is positively poled.

TABLE 1

| Electrode material | Electrode wear rate (%) |
|---|---|
| copper (Cu) | 50-200 |
| graphite (Gr) | 100-400 |
| copper tungsten (CuW) | 10-50 |

Incidentally, it is known that if a cemented carbide workpiece is machined at reverse polarity the electrode wear rate is even higher.

Use of a CVD diamond thin film in order to reduce electrode wear without recourse to protection using a carbon layer has been proposed in Iwai et al., “Application of electrically conductive diamond to removal machining 1st report: Attempt of electrodischarge machining of an electrically conductive diamond thick film”, Proceedings of the 2003 annual conference of the Japan society for abrasive technology, pages 165-166, Iwai et al., “Application of electrically conductive diamond to removal machining 2nd report: Attempt of electrodischarge machining with an electrode made of electrically conductive diamond”, Proceedings of the 2003 annual conference of the Japan society for abrasive technology, pages 167-170, and Suzuki et al., “Electrical discharge machining using electrically conductive CVD diamond as an electrode”, New diamond and frontier carbon technology, pages 1-8, Vol. 14/No. 1 (2004). A diamond thin film is formed using chemical vapor deposition (CVD), and is made conductive by boron doping.

An electrode is formed by brazing the CVD diamond thin film to the surface of a metal material. However, there are the following problems with a CVD diamond thin film electrode.
3. A CVD diamond thin film electrode is limited, due to its manufacturing method, to a small size, having a thickness of a few to a few hundred μm, and a surface area of under 15 mm×15 mm. As a result, it is difficult to form large cavities in a workpiece.
4. Conductivity of the electrode surface is limiting.
5. The CVD diamond thin film electrode is not practical for straight polarity electric discharge machining.

An object of the present invention is to provide an electrode for use in electric discharge machining capable of machining various workpieces under a wide range of electrical machining conditions while minimizing wear rate.

Another object of the present invention is to provide an electrode for use with electric discharge machining of large size capable of being precisely manufactured.

### DISCLOSURE OF THE INVENTION

In order to achieve the above described object, according to one aspect of the present invention there is provided a sintered electrode for electric discharge machining comprising a continuous phase consisting of a conductive region, and a dispersed phase consisting of microscopic polycrystalline diamond dispersed in the continuous phase.

Preferably, the sintered electrode for electric discharge machining contains a dispersed phase of 80-20% by volume, and the microscopic polycrystalline diamond has particle size of 1-60 μm.

According to another aspect of the present invention, a method of performing electric discharge machining of a workpiece wherein a sintered electrode, comprising a continuous phase consisting of a conductive region, and a dispersed phase consisting of microscopic polycrystalline diamond dispersed in the continuous phase, and the workpiece are connected to a power supply in reverse polarity.

### BRIEF DESCRIPTION OF THE DRAWINGS

FIG. 1 is a drawing schematically showing part of a sintered electrode enlarged.

FIG. 2 is a drawing schematically showing the surface of a workpiece on which an electric discharge crater is formed, enlarged.

FIG. 3 is a circuit diagram showing a power supply circuit for electric discharge machining.

FIG. 4 is a timing chart showing signal within the power supply circuit of FIG. 3.

FIG. 5 is a graph plotting electrode wear rate in relation to ON-time of a current pulse.

FIG. 6 is a graph plotting electrode wear rate in relation to ON-time of a current pulse.

### DESCRIPTION OF THE PREFERRED EMBODIMENTS

### Sintered Electrode for Electric Discharge Machining

The electrode of the present invention is a sintered compact having a continuous phase consisting of a conductive region, and a dispersed phase consisting of microscopic polycrystalline diamond dispersed in the continuous phase, firmly integrated. The continuous phase is formed from a metal or conductive material, and functions as a binder for the dispersed phase. An electrode is an integrally combined sintered compact, which means that it has excellent mechanical strength to resist the shock of electric discharge. Because a continuous conductive region is arranged over the entire sintered electrode, it is possible to set a wide range of electrical machining conditions.

<Characteristics of Dispersed Phase>

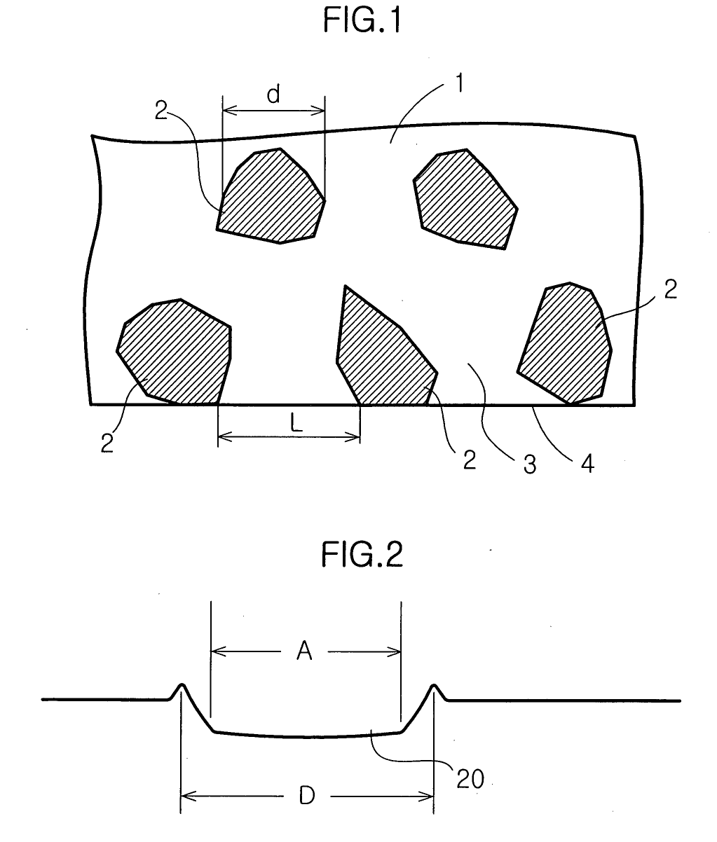

As long as the microscopic polycrystalline diamond of the dispersed phased is randomly dispersed in the continuous phase, the effects of the present invention can be expected. FIG. 1 shows a sintered electrode 1 with microscopic polycrystalline diamond 2 of average maximum length d dispersed in the conductive region 3 of the continuous phase. Microscopic polycrystalline diamond 2 on the electrode surface 4 adjoins at an average distance L. The microscopic polycrystalline diamond 2 imparts high thermal diffusion to the electrode surface 4. If a pulse voltage is applied across the gap, a high density electron flow is produced between the conductive region 3 of the electrode 1 and the conductive workpiece, that is, an electric discharge column is formed. Workpiece material exposed to the electric discharge column vaporizes or flies off, and an electric discharge crater 20 as shown in FIG. 2 remains on the workpiece surface. Reference character A denotes a workpiece region exposed to the electric discharge column, namely the diameter of the electric discharge column. Reference character D denotes the diameter of the electric discharge crater 20. If electric discharge is repeatedly generated in the gap, oil-based machining fluid is decomposed, and carbon is adhered to the electrode surface 4. Before long, a carbon layer will be formed on the entire electrode surface 4. As a result, even if conventional non-conductive microscopic polycrystalline diamond 2 exists within the electrode 1, electric discharge will be generated smoothly. The carbon layer protects the electrode surface 4 including the conductive region 3. Furthermore, since the microscopic polycrystalline diamond 2 has better thermal diffusion than the conductive region 3, wear of the electrode 1 is reduced. If the average distance L in FIG. 1 is larger than the diameter D of the electric discharge crater 20 (more accurately, the diameter A of the electric discharge column), only the conductive region 3 which easily fuses at high temperature is frequently exposed to the electric discharge column. In order to lower electrode wear, the microscopic polycrystalline diamond 2 is dispersed so that average distance L is the same as or smaller than discharge crater diameter D on the electrode surface 4. The diameter D of the electric discharge crater 20 can be predicted based mainly on peak and ON-time of a current pulse. Electrical conditions are set so that the diameter D of the electric discharge crater 20 is the same as or larger than the average distance L.

If the electrode 1 contains the dispersed phase at 80-20% by volume and the continuous phase at 20-80% by volume, the effects of the present invention can be expected. If the dispersed phase exceeds 80% by volume, it will be difficult to make the electrode surface 4 smooth. If the continuous phase exceeds 80% by volume, the mechanical strength of the electrode 1 will be lowered. Since the dispersed phase improves mechanical strength of the electrode 1, it is possible to machine a high hardness material or a material having a high melting point of 3000° C. or more easily. In order to achieve a balance between mechanical strength and a smooth surface, the electrode 1 preferable includes the dispersed phase at 40-60% by volume. More preferably, the electrode 1 contains the dispersed phase at 50-70% by volume.

Microscopic polycrystalline diamond having larger particle size causes reduced electrode wear rate, and in particular caused reduced wear rate at edges of the electrode. However, if the particle size exceeds 60 μm, it will be difficult to make the electrode surface 4 smooth. In order to achieve a balance between wear rate and a smoother surface, the electrode 1 has particle size of 1-60 μm. Particle size can be viewed using, for example, an electron microscope.

<Characteristics of the Continuous Phase>

The conductive region 3 inside the continuous phase imparts sufficient conductivity to the electrode surface 4 to enable setting of a wide range of electrical machining conditions, even if it is difficult to form the carbon layer on the electrode surface 4. Conductive region 3 is a conductive material capable of being sintered to microscopic polycrystalline diamond 2. For example, the conductive region 3 is cobalt, nickel, cobalt nickel alloy or cemented carbide.

<Manufacture of Sintered Electrode>

The sintered compact is formed using hot isostatic press (HIP) to advance compression and sintering at the same time. HIP can easily form a three dimensional sintered compact having a large level surface. By performing electric discharge machining with the sintered compact connected to a negative terminal of the power supply, the sintered compact is accurately formed into a desired shape. The surface of the sintered compact is smoothed by etching with acid or mechanical processing.

<Electric Discharge Machining Method>

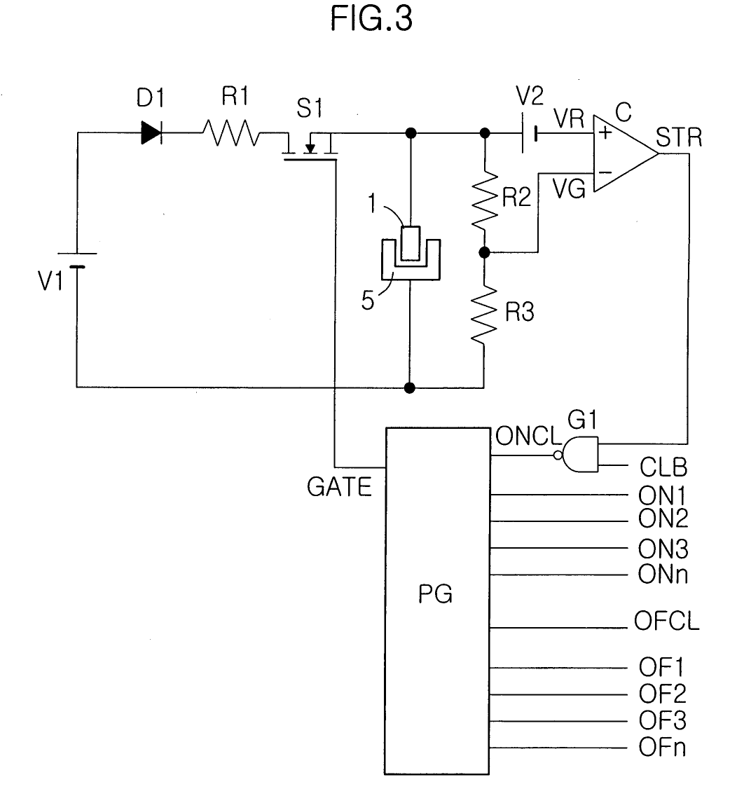

In order to realize low wear a workpiece is machined using the electrode of the present invention under specific electrical machining conditions. A current pulse is supplied to a gap at reverse polarity. ON-time of the current pulse is 500 μ seconds or less, and preferably 60 μ seconds or less and 1 μ second or more. Peak of the current pulse is 50 A or less, and preferably 15 A or less and 1 A or more. A power supply circuit suitable for implementation of the present invention is shown FIG. 3. Data representing the setting of electrical machining conditions from a control unit (not shown) are sent to a pulse generator PG. ON1-ONn are data representing ON-time of a current pulse, and OF1-OFn are data representing OFF-time of a current pulse. The pulse generator PG supplies a gate signal GATE having a set ON-time and OFF-time to a plurality of parallel switching elements S1. In order to simplify the drawing, only a single switching element S1 is shown in FIG. 3. The switching elements S1 are field effect transistors, and can supply a current pulse at a minimum of 1 μ second or less. The electrode 1 is connected to a positive terminal of a direct current power source V1 and a workpiece 5 is connected to a negative terminal of the direct current power source V1. A reverse current prevention diode D1 and a current limiting resistor R1 are connected in series with each parallel switching element S1. Current pulse peak is determined by on/off operation of the parallel switching elements S1. Detection resistors R2 and R3 supply a voltage VG across the gap to a comparator C, and a direct current power source V2 supplied a reference voltage VR to the comparator C. The detection resistors R2, R3, direct current power source V2 and comparator C constitute an electric discharge detection circuit for detecting the occurrence of electric discharge. The output STR of the comparator C is connected to one input of a NAND gate G1.

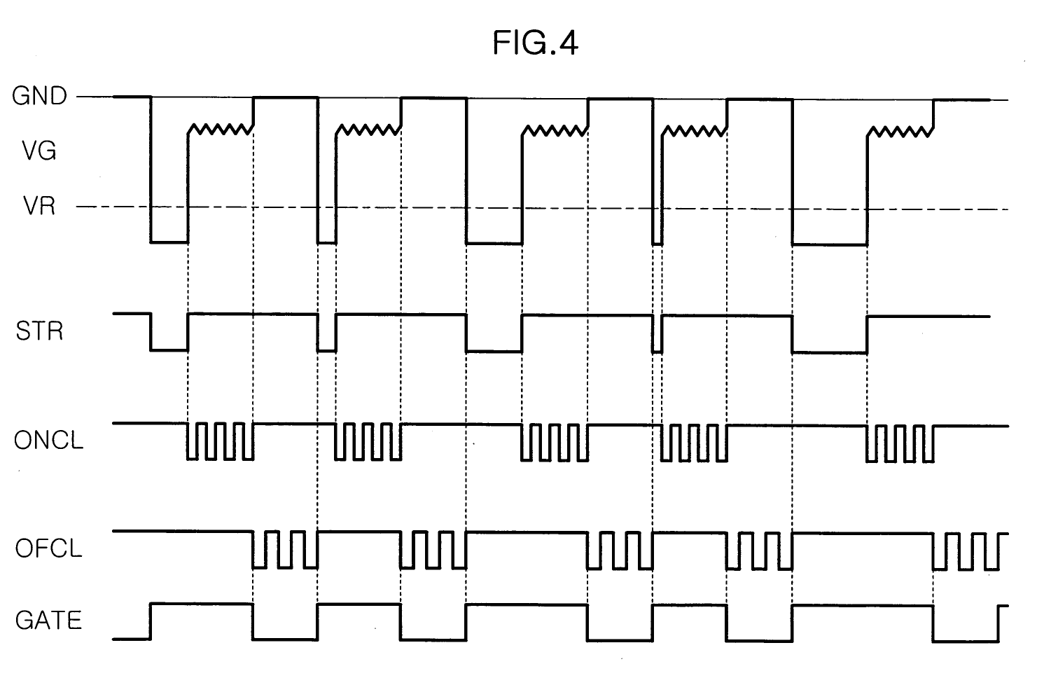

As shown in FIG. 4, if a switching element S1 is turned on, the voltage of the direct current power supply V1 is applied to the gap. If the voltage VG across the gap exceeds the reference voltage VR, the output signal STR of the comparator C becomes low level. If electric discharge is generated in the gap and the voltage VG is less than the reference voltage VR, the output signal STR of the comparator C becomes high level. While the signal STR is high level, the NAND gate G1 supplies an ON clock signal ONCL to the pulse generator PG. The pulse generator PG turns the switching element S1 off if a count value for the ON clock signal ONCL reaches a set ON-time.

### FIRST EMBODIMENT

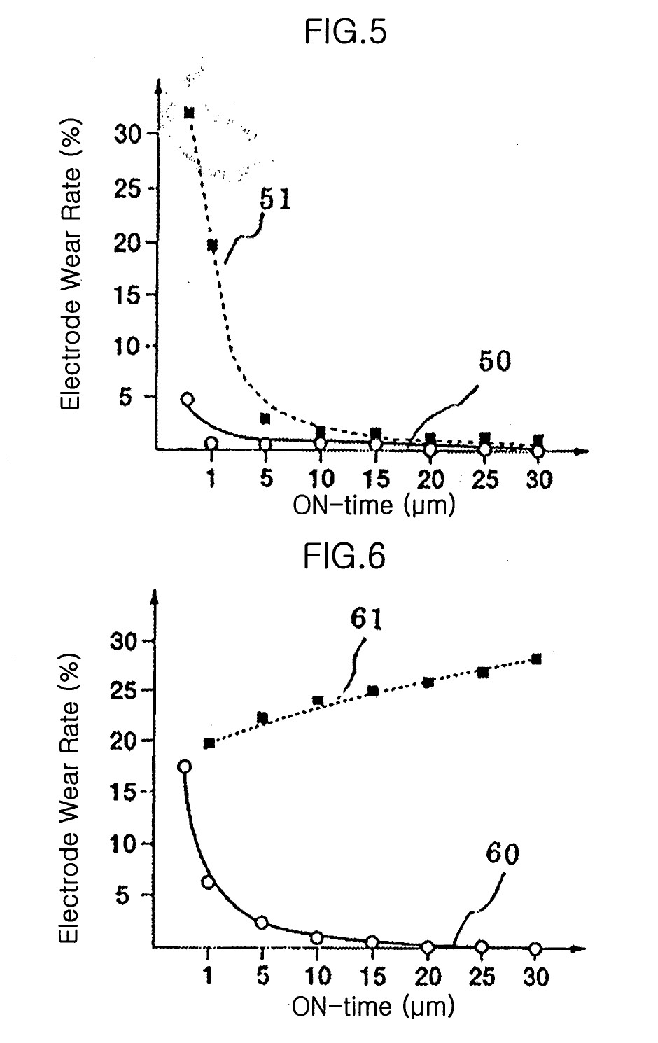

A sintered electrode comprising a continuous phase of a conductive region and a dispersed phase of synthetic polycrystalline diamond powder was used. An electrode and a steel workpiece are connected to a power supply in reverse polarity. “VITOL” manufactured by Sodick Co., Ltd. was used as machining fluid. The power supply voltage was 90V, average machining current was 1 A, and current peak was 3 A. ON-time was varied as shown in FIG. 5. Reference numeral 50 in FIG. 5 denotes the sintered electrode, and reference numeral 51 denotes a steel electrode.

### SECOND EMBODIMENT

A tungsten carbide workpiece was electric discharge machined under the same conditions as the first embodiment. Reference numeral 60 in FIG. 6 denotes the sintered electrode, and reference numeral 61 denotes a copper tungsten electrode.

### THIRD EMBODIMENT

A cavity of f 150 mm was formed in a large scale steel workpiece using a sintered electrode comprising a continuous phase of a conductive region and a dispersed phase of synthetic polycrystalline diamond powder. The electrode and the workpiece were connected to a power supply in reverse polarity, and “VITOL” manufactured by Sodick Co., Ltd. was used as machining fluid. Power supply voltage was 90V and average machining current was 5 A. The workpiece surface was finished to a surface roughness of 1 μmRz, and electrode wear rate was about 1-2%.

### FOURTH EMBODIMENT

A tungsten carbide workpiece was electric discharge machined using a sintered electrode comprising a continuous phase of a conductive region and a dispersed phase of synthetic polycrystalline diamond powder. The electrode and the workpiece were connected to a power supply in reverse polarity, and “VITOL” manufactured by Sodick Co., Ltd. was used as machining fluid. Power supply voltage was 90V and average machining current was 1 A. The workpiece surface was finished to a surface roughness of 1 μmRz.

The embodiments have been chosen in order to explain the principles of the invention and its practical applications, and many modifications are possible in light of the above teaching. It is intended that the scope of the invention be defined by the claims appended hereto.

1. A sintered electrode for electric discharge machining comprising a continuous phase consisting of a conductive region, and a dispersed phase consisting of microscopic polycrystalline diamond dispersed in the continuous phase.

2. The sintered electrode for electric discharge machining of claim 1, comprising the dispersed phase at 80-20% by volume.

3. The sintered electrode for electric discharge machining of claim 1, comprising the dispersed phase at 40-60% by volume.

4. The sintered electrode for electric discharge machining of claim 1, comprising the dispersed phase at 50-70% by volume.

5. The sintered electrode for electric discharge machining of claim 1, wherein the microscopic polycrystalline diamond has particle size of 1-60 μm.

6. The sintered electrode for electric discharge machining of claim 1, wherein the conductive region is cobalt, nickel, cobalt nickel alloy or cemented carbide.

7. A method of performing electric discharge machining of a workpiece wherein a sintered electrode, comprising a material having a continuous phase consisting of a conductive region, and a dispersed phase consisting of microscopic polycrystalline diamond dispersed in the continuous phase, and the workpiece are connected to a power supply in reverse polarity.

8. The method of performing electric discharge machining of claim 7, wherein a current pulse having ON-time of 500 μ seconds or less is supplied to the sintered electrode from the power supply.

9. The method of performing electric discharge machining of claim 7, wherein a current pulse having ON-time of 60 μ seconds or less and 1 μ second or more is supplied to the sintered electrode from the power supply.

10. The method of performing electric discharge machining of claim 7, wherein a current pulse having peak of 50 A or less is supplied to the sintered electrode from the power supply.

11. The method of performing electric discharge machining of claim 7, wherein a current pulse having peak of 15 A or less and 1 A or more is supplied to the sintered electrode from the power supply.

12. The method of performing electric discharge machining of claim 7, wherein an average distance of the microscopic polycrystalline diamond is the same as or
smaller than discharge crater diameter on the surface of the sintered electrode.
